(19) United States
(12) Patent Application Publication
(10) Pub. No.: US 2025/0008409 A1
(43) Pub. Date: Jan. 2, 2025

(54) RELAYING DATA VOLUME INFORMATION

(71) Applicant: Lenovo (Singapore) Pte. Ltd., New Tech Park (SG)

(72) Inventors: Joachim Löhr, Wiesbaden (DE); Prateek Basu Mallick, Dreieich (DE); Dimitrios Karampatsis, Ruislip (GB); Karthikeyan Ganesan, Kronberg im Taunus (DE); Ravi Kuchibhotla, Chicago, IL (US)

(21) Appl. No.: 18/701,158

(22) PCT Filed: Nov. 26, 2021
(86) PCT No.: PCT/EP2021/083155

§ 371 Date: Apr. 12, 2024

(30) Foreign Application Priority Data
Oct. 12, 2021 (GR) 20210100692

(51) Int. Cl. H04W 40/22; H04W 28/02; H04W 72/25; H04W 76/28

(52) U.S. Cl. CPC H04W 40/22; H04W 28/0278; H04W 72/25; H04W 76/28

(57) ABSTRACT

Apparatuses, methods, and systems are disclosed for relaying data volume information. One method (900) includes determining (902), at a medium access control entity of a transmitting user equipment, data volume information. The data volume information includes an identifier indicating a sidelink destination and a buffer status field indicating an amount of data available for transmission to a destination. The method (900) includes transmitting (904) the data volume information to a relay user equipment.

### FIELD

The subject matter disclosed herein relates generally to wireless communications and more particularly relates to relaying data volume information.

### BACKGROUND

In certain wireless communications networks, relay devices may be used. In such networks, UEs in communication with relay devices may not be configured in relation to each other.

### BRIEF SUMMARY

Methods for relaying data volume information are disclosed. Apparatuses and systems also perform the functions of the methods. One embodiment of a method includes determining, at a medium access control entity of a transmitting user equipment, data volume information. The data volume information includes an identifier indicating a sidelink destination and a buffer status field indicating an amount of data available for transmission to a destination. In some embodiments, the method includes transmitting the data volume information to a relay user equipment.

One apparatus for relaying data volume information includes a transmitting user equipment. In some embodiments, the apparatus includes a processor that determines, at a medium access control entity of the transmitting user equipment, data volume information. The data volume information includes an identifier indicating a sidelink destination and a buffer status field indicating an amount of data available for transmission to a destination. In various embodiments, the apparatus includes a transmitter that transmits the data volume information to a relay user equipment.

Another embodiment of a method for relaying data volume information includes transmitting, from a relay user equipment, control signaling indicating whether a medium access control entity of a transmitting user equipment is enabled to transmit data volume information to the relay user equipment. The data volume information includes an identifier indicating a sidelink destination and a buffer status field indicating an amount of data available for transmission to a destination. In some embodiments, the method includes receiving the data volume information from the transmitting user equipment.

Another apparatus for relaying data volume information includes a relay user equipment. In some embodiments, the apparatus includes a transmitter that transmits control signaling indicating whether a medium access control entity of a transmitting user equipment is enabled to transmit data volume information to the relay user equipment. The data volume information includes an identifier indicating a sidelink destination and a buffer status field indicating an amount of data available for transmission to a destination. In various embodiments, the apparatus includes a receiver that receives the data volume information from the transmitting user equipment.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for relaying data volume information;

FIG. 2 is a schematic block diagram illustrating one embodiment of an apparatus that may be used for relaying data volume information;

FIG. 3 is a schematic block diagram illustrating one embodiment of an apparatus that may be used for relaying data volume information;

FIG. 4 is a schematic block diagram illustrating one embodiment of a system for sidelink communications;

FIG. 5 is a schematic block diagram illustrating one embodiment of a system for DRX negotiation between UEs;

FIG. 6 is a schematic block diagram illustrating another embodiment of a system for DRX negotiation between UEs;

FIG. 7 is a schematic block diagram illustrating a further embodiment of a system for DRX negotiation between UEs;

FIG. 8 is a block diagram illustrating one embodiment of a MAC CE for a PC5 interface;

FIG. 9 is a flow chart diagram illustrating one embodiment of a method for relaying data volume information; and

FIG. 10 is a flow chart diagram illustrating another embodiment of a method for relaying data volume information.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

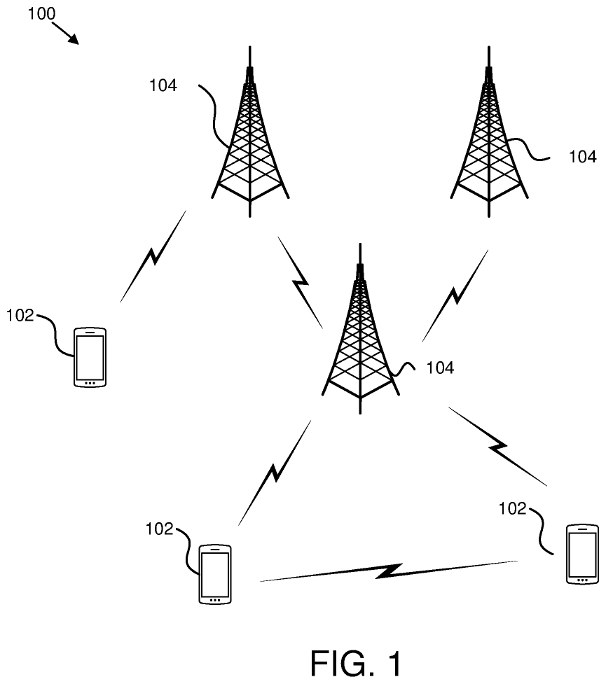

FIG. 1 depicts an embodiment of a wireless communication system 100 for relaying data volume information. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may determine, at a medium access control entity of a transmitting user equipment, data volume information. The data volume information includes an identifier indicating a sidelink destination and a buffer status field indicating an amount of data available for transmission to a destination. In some embodiments, the remote unit 102 may transmit the data volume information to a relay user equipment. Accordingly, the remote unit 102 may be used for relaying data volume information.

In certain embodiments, a remote unit 102 may transmit, from a relay user equipment, control signaling indicating whether a medium access control entity of a transmitting user equipment is enabled to transmit data volume information to the relay user equipment. The data volume information includes an identifier indicating a sidelink destination and a buffer status field indicating an amount of data available for transmission to a destination. In some embodiments, the remote unit 102 may receive the data volume information from the transmitting user equipment. Accordingly, the remote unit 102 may be used for relaying data volume information.

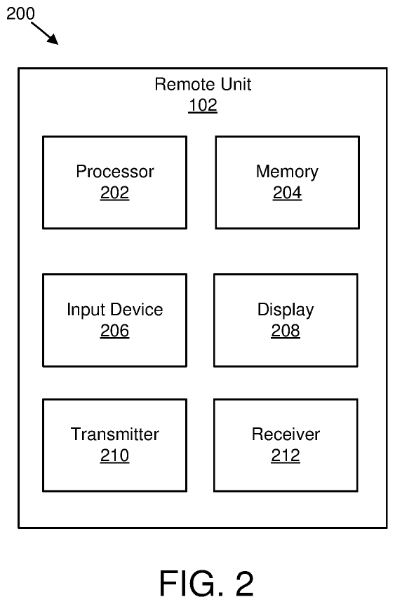

FIG. 2 depicts one embodiment of an apparatus 200 that may be used for relaying data volume information. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 determines, at a medium access control entity of the transmitting user equipment, data volume information. The data volume information includes an identifier indicating a sidelink destination and a buffer status field indicating an amount of data available for transmission to a destination. In various embodiments, the transmitter 210 transmits the data volume information to a relay user equipment.

In some embodiments, the transmitter 210 transmits control signaling indicating whether a medium access control entity of a transmitting user equipment is enabled to transmit data volume information to the relay user equipment. The data volume information includes an identifier indicating a sidelink destination and a buffer status field indicating an amount of data available for transmission to a destination. In various embodiments, the receiver 212 receives the data volume information from the transmitting user equipment.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

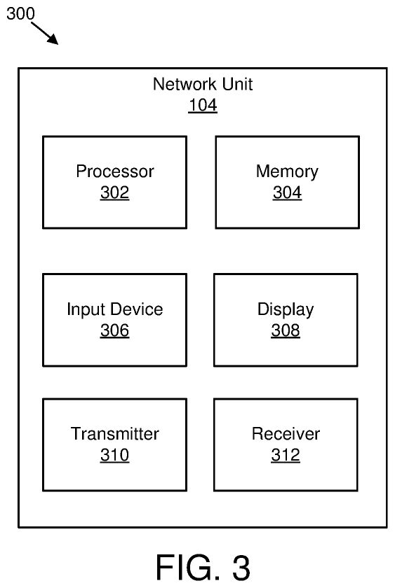

FIG. 3 depicts one embodiment of an apparatus 300 that may be used for relaying data volume information. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, there may be a user equipment (“UE”) to network coverage extension: network to UE interface (“Uu”) coverage reachability may be necessary for UEs to reach a server in a packet data network (“PDN”) or counterpart UE out of a proximity area. In some embodiments, a UE-to-network relay may be limited to an evolved universal terrestrial radio access (“EUTRA”) based technology, and thus may not be applied to new radio (“NR”) based system, for both next generation (“NG”) radio access network (“RAN”) (“NG-RAN”) and NR-based sidelink communication.

In various embodiments, there may be a UE-to-UE coverage extension: proximity reachability may be limited to a single-hop sidelink link, either via EUTRA-based or NR-based sidelink technology. However, that may not be sufficient in the scenario where there is no Uu coverage, considering the limited single-hop sidelink coverage.

In certain embodiments, for both sidelink (“SL”) relay types, a SL remote UE may need to discover and select a relay for transmissions to a SL remote. SL data transmissions from a transmitter remote UE to a receive or receiver (“RX”) remote UE may travers an intermediate relay node (e.g., relay node relays internet protocol (“IP”) traffic between transmit or transmitter (“TX”) remote and RX remote UEs). The relay may communicate with TX as well as RX remote UEs using sidelink communication over a UE to UE interface (“PC5”) interface.

In various embodiments, sidelink resource allocation behavior may be defined at a TX remote UE for the transmission of sidelink data destined for different RX remote UEs served by the same relay node.

In certain embodiments, for cases if the SL active time (“ActiveTime”) on a first PC5 interface between a TX remote UE and a UE-to-UE (“U2U”) relay UE and a second PC5 interface between the U2U relay UE and an RX remote UE are not coordinated, it may happen that the U2U relay UE receives data from the TX remote UE for a specific destination. The RX remote UE associated with the destination may not be in ActiveTime and ready to receive SL data from the relay UE on the second PC5 interface. Similarly, the RX remote UE may be in ActiveTime on the second PC5 interface even though there is no data available for transmission at the relay UE for the RX remote UE.

As used herein, UE-to-network relay may be referred to as an N-relay, a UE-to-UE relay may be referred to as a UE-relay, and a relay may be either an N-relay or a UE-relay.

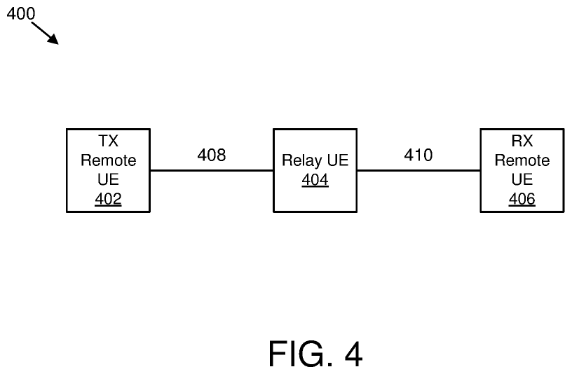

FIG. 4 is a schematic block diagram illustrating one embodiment of a system 400 for sidelink communications. In FIG. 4, a TX remote UE 402 (UE1) is a UE that has some application data to be sent to another remote UE shown as a RX remote UE 406 (UE3) via a relay UE 404 (UE2). As may be appreciated, the UE3 may have data to send to UE1 via UE2 and, in this context, UE3 would take the role of a transmitter UE. As may be appreciated, FIG. 4 is shown with respect to a particular data packet only, but it should be noted that the RX remote UE 406 may be in a multi-hop scenario also acting as a relay UE 404 (e.g., relaying the data traffic further to another RX remote UE). A first communication interface 408 is used for communications between the TX remote UE 402 and the relay UE 404, and a second communication interface 410 is used for communications between the relay UE 404 and the RX remote UE 406.

As used in various embodiments herein, each SL logical channel (“LCH”), SL service, SL application, and/or SL destination may be associated with a preconfigured and/or fixed SL discontinuous reception (“DRX”) configuration that is defined as a combination of parameters (e.g., offset_std_On-duration, On-duration-timer, and periodicity). In certain embodiments, a SL On-duration starts at a fixed time offset (e.g., called offset_std_On-duration) from Time_0 based on a sync source from a global navigation satellite system (“GNSS”) or gNB directly or indirectly from sidelink synchronization signals (“SLSS”). In some embodiments, an On-duration-timer is restarted periodically with a periodicity. It should be noted that the term SL “ActiveTime” may refer to the time period where a SL UE transmits and/or receives data and/or control on the PC5 interface.

In various embodiments, a predefined destination-specific SL DRX pattern and/or configuration ensures that the SL data transmissions for a specific application, service, destination, and/or LCH are synchronized between UEs interested in such service and/or application. The TX side of a UE may need to be aware of when RX UEs are “listening” for data of a specific SL LCH and/or application and RX side of a UE needs to know when to monitor for SL data and/or control of a specific SL LCH and/or application. Such SL DRX pattern and/or configuration may also improve a UE's power consumption, as a UE interested in a particular SL service and/or application needs to be only “active” on the PC5 interface (e.g., monitor for sidelink control information (“SCI”) and/or physical sidelink shared channel (“PSSCH”)), at specific predefined time periods. It may be also possible that a sidelink UE uses two separate DRX patterns and/or ActiveTimes (e.g., one ActiveTime defining if the SL UE acting as a transmitter is allowed to transmit SL data and/or control on the PC5 interface to the peer RX UEs and another separate DRX pattern and/or ActiveTime determining if the same SL UE, acting as a receiving UE (RX UE) is receiving SL data and/or control from the peer UE). It should be noted that the embodiments described here are applicable to both approaches (e.g., one “common” DRX pattern and/or ActiveTime per sidelink UE or two separate DRX patterns and/or ActiveTimes per SL UE—one for the TX side and one for the RX side).

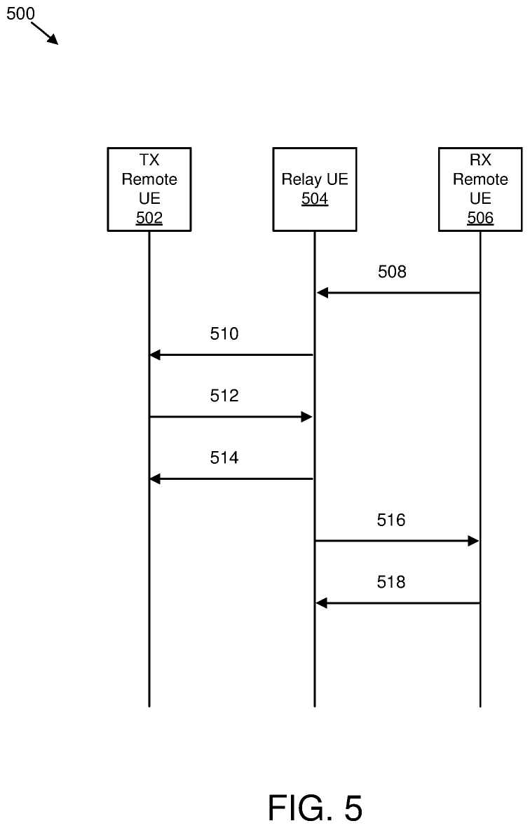

FIG. 5 is a schematic block diagram illustrating one embodiment of a system 500 for DRX negotiation between UEs. The system 500 includes a TX remote UE 502, a relay UE 504, and an RX remote UE 506. It should be noted that any of the communications described herein may include one or more messages.

In a first communication 508, the RX remote UE 506 provides some DRX related assistance information to the relay UE 504, which in a second communication 510 are in turn forwarded by the relay UE 504 to the TX remote UE 502. The relay UE 504 just forwards the DRX related assistance information from the RX remote UE 506 to the TX remote UE 502. In one example, the assistance information may include a DRX configuration information. Such DRX configuration information may be an aggregation of RX remote UEs ActiveTime and/or Onduration configuration (e.g., the RX remote UE 506 may be in communication with multiple UEs and the aggregated DRX and/or ActiveTime information considers the communications with all UEs). The TX remote UE 502 takes this information into account to configure the SL DRX configuration between the TX remote UE 502 and the relay UE 504 (e.g., first PC5 link).

Furthermore, in a third communication 512, the TX remote UE 502 also configures the SL DRX configuration between the relay UE 504 and RX remote UE 506 (e.g., SL DRX for the second PC5 link and signals the DRX configuration to the relay UE 504 which in turn in a fifth communication 516 forwards this information to the RX remote UE 506). The TX remote UE 502 considers the transmission delay on the first PC5 link and a potential processing delay at the relay UE 504 when determining the SL DRX configuration for the second PC5 link. According to this embodiment, the relay UE 504 plays no active role in determining and/or configuration the SL DRX configuration on the first and second PC5 link. In one example, DRX related assistance information is signaled by PC5-RRC signaling (e.g., RX remote UE 506 signals the assistance information to the relay UE 504 via PC5 RRC signaling (e.g., UE Assistance information message). For example, the PC5 RRC messages of the SL RRC reconfiguration procedure for configuring the SL DRX configuration used between a pair of UEs of a unicast link (e.g., pair of source and/or destination) may be used. Similarly, the relay UE 504 may forward the DRX related assistance information from the RX remote UE 506 to the TX remote UE 502 using a PC5 RRC signaling. In such scenarios, the relay UE 504 adapts its DRX cycle according to the DRX negotiated between the two UEs and monitors messages from the two UEs according to the negotiated DRX. In one embodiment, the relay UE 504 maintains a PC5 DRX configuration per pair of unicast links between two remote UEs. Such PC5 RRC procedure may be used for the case that the relay UE 504 is a layer 3 U2U relay. In another example, (e.g., for cases when the relay UE 504 is a layer 2 U2U relay) the adaptation layer protocol is used to configure the DRX configuration for the first and second PC5 link. The RX remote UE 506 uses an adaptation layer message to provide DRX related assistance information to the relay UE 504. The relay UE 504 in turn forwards the DRX related assistance information to the TX remote UE 502. The TX remote UE 502 configures the SL DRX configuration between the TX remote UE 502 and the relay UE 504 and the relay UE 504 and the RX remote UE 506 using adaptation layer signaling. In one embodiment, the relay UE 504 maintains in the adaptation layer the PC5 DRX configuration negotiated per pair of PC5 bearers between two remote UEs. Alternatively, MAC control signaling may be used instead of adaptation layer signaling for the SL DRX configuration procedure for the first and second PC5 link. In a fourth communication 514, the relay UE 504 transmits an RRC reconfiguration complete sidelink message to the TX remote UE 502, and in a sixth communication 518, the RX remote UE 506 transmits an RRC reconfiguration complete sidelink message to the relay UE 504.

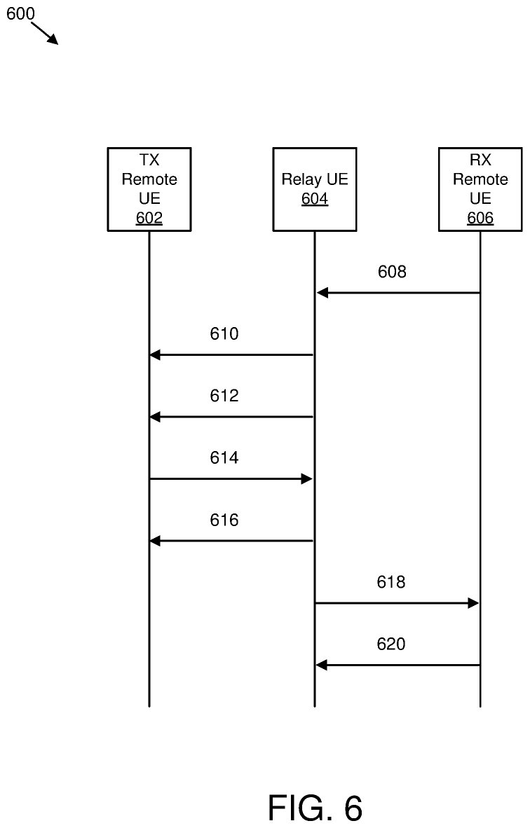

FIG. 6 is a schematic block diagram illustrating another embodiment of a system 600 for DRX negotiation between UEs. The system 600 includes a TX remote UE 602, a relay UE 604, and an RX remote UE 606. It should be noted that any of the communications described herein may include one or more messages.

In a first communication 608, the RX remote UE 606 transmits DRX assistance information to the relay UE 604. In a second communication 610 and a third communication 612, the relay UE 604 forwards two DRX related assistance information to the TX remote UE 602 (e.g., one from the relay UE 604 (in the third communication 612) perspective and one from the remote RX remote UE 606 (in the second communication 610) perspective. These two DRX assistance information may be transmitted in separate messages (e.g., separate PC5 RRC messages). Alternatively, in some embodiments, the two DRX assistance information may be transmitted in one single message. The TX remote UE 602 considers both assistance DRX information to determine SL DRX configurations for the first link and for the second link, thereby also accounting for transmission delays on the first PC5 link and processing delays at the relay UE 604. In a fourth communication 614, an RRC reconfiguration sidelink message for the DRX configuration of the relay UE 604 and the RX remote UE 606 is sent to the relay UE 604. In a fifth communication 616, the relay UE 604 sends a RRC reconfiguration complete sidelink message to the TX remote UE 602. Moreover, in a sixth communication 618, the relay UE 604 sends an RRC reconfiguration sidelink message for DRX configuration of the RX remote UE 606 (e.g., second PC5 link) to the RX remote UE 606. Further, in a seventh communication 620, the RX remote UE 606 sends a RRC reconfiguration complete sidelink message to the relay UE 604.

In various embodiments, the TX remote UE prioritizes the optimization of RX remote UE's power consumption when determining the DRX configurations. In another embodiment, a relay UE's power consumption is optimized by TX remote UE when establishing the DRX configurations on the two PC5 interfaces given that the relay UE may serve multiple RX remote UEs. It should be noted that when determining and/or configuring the DRX configurations for two PC5 interfaces, a TX remote UE should always ensure that quality of service (“QoS”) requirements of services and/or sidelink radio bearers are fulfilled.

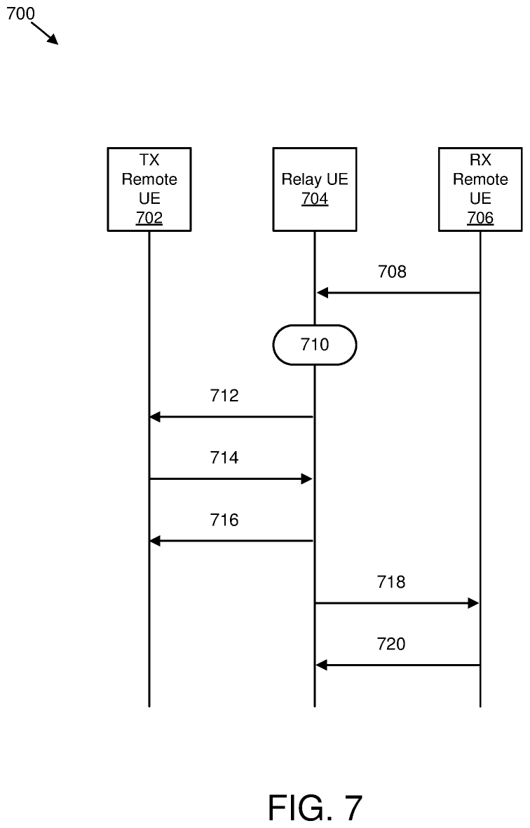

FIG. 7 is a schematic block diagram illustrating a further embodiment of a system 700 for DRX negotiation between UEs. The system 700 includes a TX remote UE 702, a relay UE 704, and an RX remote UE 706. It should be noted that any of the communications described herein may include one or more messages.

In a first communication 708, the RX remote UE 706 transmits DRX assistance information (“AI”) to the relay UE 704. Moreover, the relay UE 704 incorporates 710 DRX related assistance information received from the RX remote UE 706 at the relay UE 704. The relay UE 704 determines the DRX related assistance information to be sent to the TX remote UE 702 in a second communication 712 by considering its own SL DRX configurations and the AI received from the RX remote UE 706. According to FIG. 7, the relay UE 704 forwards DRX related assistance information to the TX remote UE 702 in the second communication 712. According to this example, the relay UE 704 negotiates the SL DRX configuration with the TX remote UE 702 for the two PC5 links. Specifically, in a third communication 714, an RRC reconfiguration sidelink message for DRX configuration of the relay UE 704 (e.g., first PC5 link) and the RX remote UE 706 (e.g., second PC5 link) is sent to the relay UE 704. In a fourth communication 716, the relay UE 704 sends a RRC reconfiguration complete sidelink message to the TX remote UE 702. Moreover, in a fifth communication 718, the relay UE 704 sends an RRC reconfiguration sidelink for DRX of the RX remote UE 706 to the RX remote UE 706. Further, in a sixth communication 720, the RX remote UE 706 sends a RRC reconfiguration complete sidelink message to the relay UE 704.

In some embodiments, a TX remote UE provides some buffer status related information to the relay UE for the purpose of controlling and/or adapting DRX behavior on the second PC5 link, e.g., PC5 link between relay UE and RX remote UE. To ensure that the RX remote UE is in ActiveTime for receiving SL data from the relay UE if the relay UE receives new data from the TX remote UE, the TX remote UE provides some information related to the amount of data available for transmission to the RX remote UE. Based on the data volume information provided by the TX remote UE, the relay UE may adapt the DRX status of the RX remote UE, e.g., for cases when more data is expected from the TX remote UE, the relay UE keeps the RX remote UE in ActiveTime. In various embodiments, buffer status reporting is introduced for the PC5 link between the TX remote UE and the relay UE. The sidelink buffer status reporting (“SL-BSR”) procedure is used to provide the relay UE with information about SL data volume in the TX remote UE's MAC entity to control the DRX state of the RX remote UE. The new PC5 SL BSR MAC CE format may be similar to the SL BSR MAC CE defined for buffer status reporting to the serving gNB on the Uu interface.

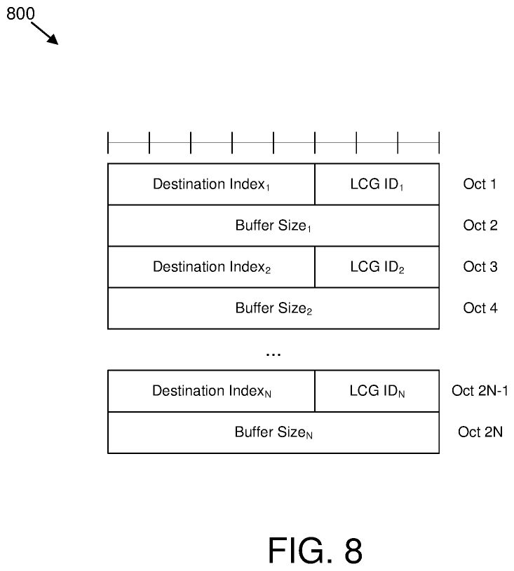

FIG. 8 is a block diagram illustrating one embodiment of a MAC CE 800 for a PC5 interface. As shown in FIG. 8, there may be one or more destination index present in the SL-BSR MAC CE. However, the actual 24 bits long destination identifier (“ID”) corresponding to each index value may need to be separately and previously signaled between the sidelink UEs. Like on Uu, a SL-DestinationIdentity associated to same destination reported may be reported on PC5 RRC in a SidelinkUEInformationNR like PC5 messages. This may enable both the sender and receiver of the SL-BSR MAC CE to know which destination IDs are meant by each of the index values.

In certain embodiments, a relay UE may request a TX remote UE to enable buffer status reporting for certain destinations and/or RX remote UEs. In one example, a new signaling message is used (e.g., PC5 RRC message) which requests the TX UE to provide and/or enable buffer status reporting for certain indicated destinations or all destinations.

In some embodiments, certain parameters may be configured for the TX remote UE which control the sidelink buffer status reporting to the relay UE. In one example, a timer is configured which enables periodic SL buffer status reporting to the relay UE. Furthermore, and according to various embodiments, trigger conditions are defined for the SL BSR reporting from a TX remote UE to the relay UE. In one example, the TX remote UE informs the relay UE that there is no data available for transmission to all destinations or a configured set of destinations. In certain embodiments, a relay UE is informed if the TX remote UE has no more data to transmit to any of the destinations. This information may be used by the relay UE to indicate to the RX remote UE to go to a sleep mode (e.g., for specific destinations and/or services). In one example, a TX UE triggers the reporting of buffer status information to the relay UE if a new destination served by the relay is added (e.g., new sidelink resource block (“SLRB”) is added), or an existing destination is removed (e.g., SL bearer is removed).

In some embodiments, a destination ID in the new PC5 SL buffer status information is the destination of the RX remote UE.

In various embodiments, a new control signaling indicates to the recipient to stay in DRX ActiveTime for a certain period of time. The receiver starts, upon reception of such control signal, a timer that controls the time the UE considers itself to be in ActiveTime. As long as the timer is running, the UE is in DRX ActiveTime and monitors PSCCH and/or PSSCH. In certain embodiments, a relay UE uses new control signaling to indicate to a RX remote UE to stay in ActiveTime for a certain time period. In some embodiments, control signaling indicates a time period for which a UE should stay in ActiveTime. In various embodiments, a time period is not explicitly indicated, but preconfigured. In certain embodiments, a new control message indicates destination IDs for which a UE should stay in ActiveTime. In one example, the new control message is signaled on a PSCCH (e.g., via SCI). In one implementation, a set of reserved bits within an SCI format 1-A indicates to a recipient to stay in ActiveTime for a certain defined time period. In some embodiments, a new SCI format may be used to convey new control signaling. In the SCI format 1-A illustrated in Table 1, there may be reserved and/or unused bits that may be used to indicate to a receiving UE to stay in ActiveTime.

TABLE 1
SCI format 1-A

```
SCI format 1-A is used for the scheduling of PSSCH and 2nd-stage-
SCI on PSSCH
The following information is transmitted by means of the SCI format
1-A:
  Priority - 3 bits as specified in clause 5.4.3.3 of [12, TS 23.287] and
clause 5.22.1.3.1 of [8, TS 38.321].
  $Frequency resource assignment - ⌈ {log}_{2} ( \frac{{N}_{subChannel}^{S L} ( {N}_{subChannel}^{S L} + 1 )}{2} ) ⌉$
  bits when the value of the higher layer parameter sl-
  MaxNumPerReserve is configured to 2; otherwise
  $⌈ {log}_{2} ( \frac{{N}_{subChannel}^{S L} ( {N}_{subChannel}^{S L} + 1 ) ( 2 {N}_{subChannel}^{S L} + 1 )}{6} ) ⌉ bits when the value$
  value of the higher layer parameter sl-MaxNumPerReserve is
  configured to 3, as defined in clause 8.1.2.2 of [6, TS 38.214].
  Time resource assignment - 5 bits when the value of the higher
  layer parameter sl-MaxNumPerReserve is configured to 2;
  otherwise 9 bits when the value of the higher layer parameter sl-
  MaxNumPerReserve is configured to 3, as defined in clause 8.1.2.1
  of [6, TS 38.214].
  Resource reservation period - ┌log₂ Nᵣₛᵥ_period┐ bits as defined
  in clause 8.1.4 of [6, TS 38.214], where Nᵣₛᵥ_period is the number
  of entries in the higher layer parameter sl-
  ResourceReservePeriodList, if higher layer parameter sl-
  MultiReserveResource is configured; 0 bit otherwise.
  demodulation reference signal (“DMRS”) pattern - ┌log₂ Nₚₐₜₜₑᵣₙ┐
  bits as defined in clause 8.4.1.1.2 of [4, TS 38.211], where Nₚₐₜₜₑᵣₙ
  is the number of DMRS patterns configured by higher layer
  parameter sl-PSSCH-DMRS-TimePatternList.
  2^{nd}-stage SCI format - 2 bits as defined in Table 8.3.1.1-1.
  Beta_offset indicator - 2 bits as provided by higher layer
  parameter sl-BetaOffsets2ndSCI and Table 8.3.1.1-2.
  Number of DMRS port - 1 bit as defined in Table 8.3.1.1-3.
  Modulation and coding scheme - 5 bits as defined in clause 8.1.3
  of [6, TS 38.214].
  Additional modulation and coding scheme (“MCS”) table
  indicator - as defined in clause 8.1.3.1 of [6, TS 38.214]: 1 bit if
  one MCS table is configured by higher layer parameter sl-
  Additional-MCS-Table; 2 bits if two MCS tables are configured
  by higher layer parameter sl- Additional-MCS-Table; 0 bit
  otherwise.
  physical sidelink feedback channel (“PSFCH”) overhead
  indication - 1 bit as defined clause 8.1.3.2 of [6, TS 38.214] if
  higher layer parameter sl-PSFCH-Period = 2 or 4; 0 bit otherwise.
  Reserved - a number of bits as determined by higher
  layer parameter sl-NumReservedBits, with value set to zero.
```

In various embodiments, a new MAC control element is used for ordering a receiving UE to stay in ActiveTime.

In certain embodiments, a TX remote UE informs a relay UE that there is no data available for a set of destinations of its peer receiving UEs. In one implementation of this embodiment, the relay UE is informed if the TX remote UE has no more data to transmit to any of the destinations. In such cases, the TX remote UE indicates to the relay UE that it is going to sleep (e.g., on the PC5 interface) for a specific time period, at least with respect to a transmit radio frequency (“RF”) chain. Whether the RX RF chain can also sleep may depend on an indication from its peer receivers confirming that they do not have data for the TX remote UE.

In some embodiments, a TX remote UE may signal for how long it will enter a sleep mode on a first PC5 interface. Such indication may be signaled within a new MAC CE and/or radio resource configuration (“RRC”) signaling (e.g., assistance information) or within a SCI. If there is no explicit signaling for the time period of sleep, a next on-duration timer may be used to assume the time if the TX remote UE goes active.

In various embodiments, a transmitting remote UE selects, during a sidelink logical channel prioritization procedure, a relay UE based on a selected destination associated with the relay UE. According to one implementation of this embodiment, the UE selects a destination among logical channels and/or MAC CE fulfilling certain conditions related to the configured LCH mapping restrictions (e.g., highest priority logical channel), and determines the relay UE, if any, associated with the selected destination. In a subsequent step of an LCP procedure, the UE selects the SL logical channels which are served by the selected relay UE (e.g., sidelink logical channels which are relayed to a RX remote UE by the selected relay UE). According to one implementation of the embodiment, the UE considers the selected sidelink logical channels as described in the previous step for the allocation of sidelink resources and/or transmission of a transport block (“TB”) on the first PC5 interface (e.g., transmission from the TX remote UE to the selected relay UE). It should be noted that the UE may multiplex data of different destinations into one TB.

In certain embodiments, mapping restrictions configured for a SL logical channel are not considered for an LCP procedure on a first PC5 interface (e.g., all mapping restrictions are considered as satisfied during an LCP procedure on the first PC5 interface from a TX remote UE to a relay UE). The mapping restrictions which are configured by RRC to control the LCP procedure are only effective and/or considered for the second PC5 interface (e.g., relay UE considers the configured LCH mapping restrictions when performing LCP procedure). In some embodiments, a TX remote UE may not consider the LCH mapping restriction sl-HARQ-FeedbackEnabled when performing an logical channel prioritization (“LCP”) procedure for the first PC5 interface (e.g., sl-HARQ-FeedbackEnabled is only considered for the second PC5 interface).

In some embodiments, a destination ID for buffer status information sent from a TX UE to a gNB for requesting SL resources for transmission of SL data to a relay UE is set to a relay UE ID. According to one implementation of these embodiments, the TX remote UE uses the destination ID of the relay UE in a SL buffer status report (“BSR”) medium access control (“MAC”) control element (“CE”) requesting SL resources from the gNB for the transmission of data that is intended to the RX remote UE. Since the gNB allocates SL resource on the first PC5 interface, the SL BSR MAC CE may indicate the relay UE ID as the destination ID rather than the layer 2 ID of the RX remote UE.

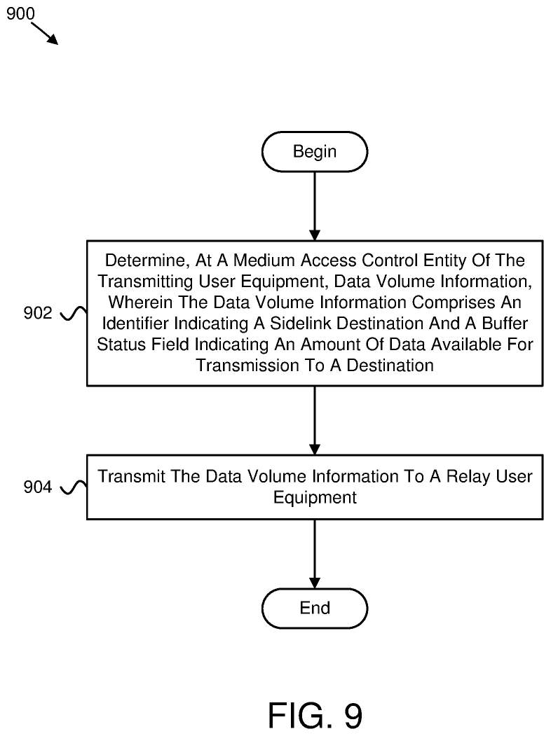

FIG. 9 is a flow chart diagram illustrating one embodiment of a method 900 for relaying data volume information. In some embodiments, the method 900 is performed by an apparatus, such as the remote unit 102. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes determining 902, at a medium access control entity of a transmitting user equipment, data volume information. The data volume information includes an identifier indicating a sidelink destination and a buffer status field indicating an amount of data available for transmission to a destination. In some embodiments, the method 900 includes transmitting 904 the data volume information to a relay user equipment.

In certain embodiments, the method 900 further comprises receiving control signaling indicating whether the medium access control entity of the transmitting user equipment is enabled to transmit the data volume information to the relay user equipment. In some embodiments, the control signaling is part of user equipment to user equipment radio resource signaling.

In various embodiments, the control signaling comprises information indicating a timer for enabling periodic buffer status reporting. In one embodiment, a discontinuous reception state of a remote user equipment is determined based on the data volume information.

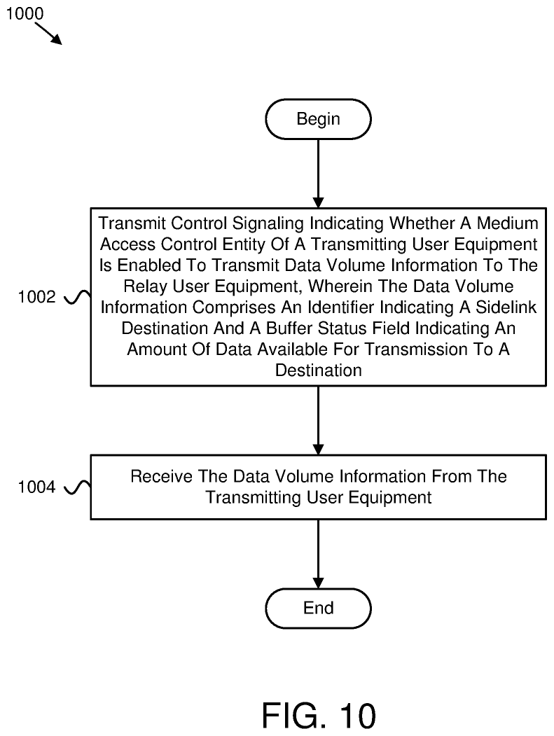

FIG. 10 is a flow chart diagram illustrating another embodiment of a method 1000 for relaying data volume information. In some embodiments, the method 1000 is performed by an apparatus, such as the remote unit 102. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes transmitting 1002, from a relay user equipment, control signaling indicating whether a medium access control entity of a transmitting user equipment is enabled to transmit data volume information to the relay user equipment. The data volume information includes an identifier indicating a sidelink destination and a buffer status field indicating an amount of data available for transmission to a destination. In some embodiments, the method 1000 includes receiving 1004 the data volume information from the transmitting user equipment.

In certain embodiments, the control signaling is part of user equipment to user equipment radio resource signaling. In some embodiments, the control signaling comprises information indicating a timer for enabling periodic buffer status reporting.

In various embodiments, a discontinuous reception state of a remote user equipment is based on the data volume information. In one embodiment, the method 1100 further comprises transmitting the data volume information to a remote user equipment.

In one embodiment, a method of a transmitting user equipment comprises: determining, at a medium access control entity of the transmitting user equipment, data volume information, wherein the data volume information comprises an identifier indicating a sidelink destination and a buffer status field indicating an amount of data available for transmission to a destination; and transmitting the data volume information to a relay user equipment.

In certain embodiments, the method further comprises receiving control signaling indicating whether the medium access control entity of the transmitting user equipment is enabled to transmit the data volume information to the relay user equipment.

In some embodiments, the control signaling is part of user equipment to user equipment radio resource signaling.

In various embodiments, the control signaling comprises information indicating a timer for enabling periodic buffer status reporting.

In one embodiment, a discontinuous reception state of a remote user equipment is determined based on the data volume information.

In one embodiment, an apparatus comprises a transmitting user equipment. The apparatus further comprises: a processor that determines, at a medium access control entity of the transmitting user equipment, data volume information, wherein the data volume information comprises an identifier indicating a sidelink destination and a buffer status field indicating an amount of data available for transmission to a destination; and a transmitter that transmits the data volume information to a relay user equipment.

In certain embodiments, the apparatus further comprises a receiver that receives control signaling indicating whether the medium access control entity of the transmitting user equipment is enabled to transmit the data volume information to the relay user equipment.

In some embodiments, the control signaling is part of user equipment to user equipment radio resource signaling.

In various embodiments, the control signaling comprises information indicating a timer for enabling periodic buffer status reporting.

In one embodiment, a discontinuous reception state of a remote user equipment is determined based on the data volume information.

In one embodiment, a method of a relay user equipment comprises: transmitting control signaling indicating whether a medium access control entity of a transmitting user equipment is enabled to transmit data volume information to the relay user equipment, wherein the data volume information comprises an identifier indicating a sidelink destination and a buffer status field indicating an amount of data available for transmission to a destination; and receiving the data volume information from the transmitting user equipment.

In certain embodiments, the control signaling is part of user equipment to user equipment radio resource signaling.

In some embodiments, the control signaling comprises information indicating a timer for enabling periodic buffer status reporting.

In various embodiments, a discontinuous reception state of a remote user equipment is based on the data volume information.

In one embodiment, the method further comprises transmitting the data volume information to a remote user equipment.

In one embodiment, an apparatus comprises a relay user equipment. The apparatus further comprises: a transmitter that transmits control signaling indicating whether a medium access control entity of a transmitting user equipment is enabled to transmit data volume information to the relay user equipment, wherein the data volume information comprises an identifier indicating a sidelink destination and a buffer status field indicating an amount of data available for transmission to a destination; and a receiver that receives the data volume information from the transmitting user equipment.

In certain embodiments, the control signaling is part of user equipment to user equipment radio resource signaling.

In some embodiments, the control signaling comprises information indicating a timer for enabling periodic buffer status reporting.

In various embodiments, a discontinuous reception state of a remote user equipment is based on the data volume information.

In one embodiment, the transmitter transmits the data volume information to a remote user equipment.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A processor for wireless communication, comprising:
at least one controller coupled with at least one memory and configured to cause the processor to:
determine, at a medium access control (MAC) entity of a transmitting user equipment (UE), data volume information, wherein the data volume information comprises an identifier (ID) indicating a sidelink destination and a buffer status field indicating an amount of data available for transmission to a destination; and
transmit the data volume information to a relay UE.

2. The processor of claim 1, wherein the at least one controller is configured to cause the processor to receive control signaling indicating whether the MAC entity of the transmitting UE is enabled to transmit the data volume information to the relay UE.

3. The processor of claim 2, wherein the control signaling is part of UE to UE radio resource signaling.

4. The processor of claim 2, wherein the control signaling comprises information indicating a timer for enabling periodic buffer status reporting.

5. The processor of claim 1, wherein the at least one controller is configured to cause the processor to determine a discontinuous reception (DRX) state of a remote UE based on the data volume information.

6. A transmitting user equipment (UE), comprising:
at least one memory; and
at least one processor coupled with the at least one memory and configured to cause the UE to:
determine, at a medium access control (MAC) entity of the transmitting UE, data volume information, wherein the data volume information comprises an identifier (ID) indicating a sidelink destination and a buffer status field indicating an amount of data available for transmission to a destination; and
transmit the data volume information to a relay UE.

7. The transmitting UE of claim 6, wherein the at least one processor is configured to cause the transmitting UE to receive control signaling indicating whether the MAC entity of the transmitting UE is enabled to transmit the data volume information to the relay UE.

8. The transmitting UE of claim 7, wherein the control signaling is part of UE to UE radio resource signaling.

9. The transmitting UE of claim 7, wherein the control signaling comprises information indicating a timer for enabling periodic buffer status reporting.

10. The transmitting UE of claim 6, wherein a discontinuous reception (DRX) state of a remote UE is determined based on the data volume information.

11. A relay user equipment (UE), comprising:
at least one memory; and
at least one processor coupled with the at least one memory and configured to cause the relay UE to:
transmit control signaling indicating whether a medium access control (MAC) entity of a transmitting UE is enabled to transmit data volume information to the relay UE, wherein the data volume information comprises an identifier (ID) indicating a sidelink destination and a buffer status field indicating an amount of data available for transmission to a destination; and
receive the data volume information from the transmitting UE.

12. The relay UE of claim 11, wherein the control signaling is part of UE to UE radio resource signaling.

13. The relay UE of claim 11, wherein the control signaling comprises information indicating a timer for enabling periodic buffer status reporting.

14. The relay UE of claim 11, wherein a discontinuous reception (DRX) state of a remote UE is based on the data volume information.

15. The relay UE of claim 11, wherein the at least one processor is configured to cause the UE to transmit the data volume information to a remote UE.

16. A processor for wireless communication, comprising:
at least one controller coupled with at least one memory and configured to cause the processor to:
transmit control signaling indicating whether a medium access control (MAC) entity of a transmitting user equipment (UE) is enabled to transmit data volume information to a relay UE, wherein the data volume information comprises an identifier (ID) indicating a sidelink destination and a buffer status field indicating an amount of data available for transmission to a destination; and
receive the data volume information from the transmitting UE.

17. The processor of claim 16, wherein the control signaling is part of UE to UE radio resource signaling.

18. The processor of claim 16, wherein the control signaling comprises information indicating a timer for enabling periodic buffer status reporting.

19. The processor of claim 16, wherein a discontinuous reception (DRX) state of a remote UE is based on the data volume information.

20. The processor of claim 16, wherein the at least one controller is configured to cause the transmitting UE to transmit the data volume information to a remote UE.
